(19) United States
(12) Patent Application Publication
(10) Pub. No.: US 2002/0076683 A1
(43) Pub. Date: Jun. 20, 2002

(54) Real time audio assisted instructional device

(76) Inventor: Jack Chen, Hsinchu (TW)

Correspondence Address: BIRCH STEWART KOLASCH & BIRCH, PO BOX 747, FALLS CHURCH, VA, 22040-0747, US

(21) Appl. No.: 09/735,462

(22) Filed: Dec. 14, 2000

(51) Int. Cl. G09B 5/00

(52) U.S. Cl. 434/317

(57) ABSTRACT

A real time audio assisted instructional device includes a label and an audible instructional unit. The label, containing index of sound information, can be attached to a book or other object that is to be learned. The audible instructional unit can read the label and generate audible information for a real time instruction. Sound information, such as names, relative information of objects and music, are stored in a detachable memory unit of the audible instructional unit. This instructional device incorporates the objects and the sounds, makes a real-time audible instruction possible with any object or medium, and increase the fun and efficiency of learning.

### BACKGROUND OF THE INVENTION

1. Field of Invention

The present invention generally relates to an audio assisted instructional device, and more particularly relates to a real time audio assisted instructional device, which includes a label and an audible instructional unit. The label can be attached to a book or other object that is to be learned. The unit can scan the label and generate audible information for a real time instruction.

2. Related Art

Conventional instructional materials are mainly books or pictorial media having words or pictures printed on papers. This kind of instructional material can help those students or adults that have been familiar with fundamental knowledge and capable of recognizing words or characters. The efficiency of learning mainly depends on attitude and capability of the learner, and less depends on the contents of the materials. But, for those kids before school age or persons who know less or none of the words, the books or pictorial materials can help a few. They need helps of parents or other instructors, or also assistant apparatus, such as audio or video instructional materials. The most popular assistant materials are based on audio functions, for example, audio and videocassettes.

Some audio assisted materials include books as major materials and cassettes as supplementary materials. The cassettes require a player or recorder to play. During playing, the learner has to catch up with the successive program, and is hard to pass over specific portions if desired. It is also difficult to repeat with a specific portion of the program if the player is not specially equipped with the function. Therefore the efficiency and function of the common audible instructional materials are not good enough.

Recently, computerized multimedia instructional materials utilize the audio and video processing capabilities of computer and provide an interactive learning environment for the users. Through the computerized multimedia instruction is interesting and versatile) it requires the computer facilities that are rather expensive. To operate the computer also requires skills that are not easy for small children. Therefore, it is not always easy and suitable for everybody.

There has been a scanning and audible pen in the market. The pen reads barcodes printed on a newspaper and transforms them into speech output. The verbal data are stored in the unit for the transformation purpose. It is used for “reading” newspaper only. No other instructional usage or expandable functions can be obtained.

### SUMMARY OF THE INVENTION

It is therefore an object of the present invention to provide an audio assisted instructional device, which can be used with a book or other object that is to be learned, so as to achieve an inventive and interesting learning manner departing from conventional text and picture reading by books.

Another object of the present invention is to solve problems of conventional audible books or computerized multimedia materials, and provide a real-time responsive learning assistant device which can be freely used to read materials at anytime from any entry without limitation of successive reading that a tape has.

A further object of the present invention is to provide an audio assisted instructional device, which is easy to expand its usage, inexpensive of cost, and easy to operate.

Yet another object of the present invention is to provide an audio assisted instructional device, which is suitable for children before school age.

To achieve the aforesaid object, an audio assisted instructional device includes a label carrying index of information to be learned, and an audible instructional unit composed of memory unit, recognition and search unit, and audio output unit. The label can be attached to a book or other object that is to be learned. The audible instructional unit can scan the label and generate sound information for a real time instruction. The memory unit can be detached from the audible instructional unit that includes at least a recognition and search unit and an audio output unit, so that a changeable memory unit with different contents can be replaced to expand the instructional materials with the single audible instructional unit.

Each label according to the present invention relates to an instructional sound information stored in the memory unit. The label is printed in a book or prepared as a sticker attachable to an object to be learned, e.g., a telephone or a vase. Then, when the audible instructional unit scanning the label adhered to a telephone, it will play a sound, like “This is a telephone”, to instruct the user.

For an instructional purpose, the user can use the instructional unit first with a label printed in a learning medium (such as a book) to get a question, then find out the answer, perhaps some text or a picture, and further point out an answer, where the correct label or other instructional label located, with the instructional unit to obtain a response of appreciation or instruction. Another example is that the user can use the instructional unit on a certain label to start some background music before starting other learning from a medium.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein;

FIG. 1 is a block diagram showing a composition of the present invention;

FIG. 2 is a perspective view of an audible instructional unit included in the present invention;

FIG. 3 is an exploded view of an audible instructional unit included in the present invention;

FIG. 4 is a perspective view of another embodiment of audible instructional unit included in the present invention;

FIG. 5 shows an example of application of the present invention in which a book is used.

FIG. 6 shows a second example of application of the present invention in which a label attached to an object is used.

FIG. 7 shows a third example of application of the present invention in which several labels printed in medium to accomplish an interactive learning is applied.

### DETAILED DESCRIPTION OF THE INVENTION

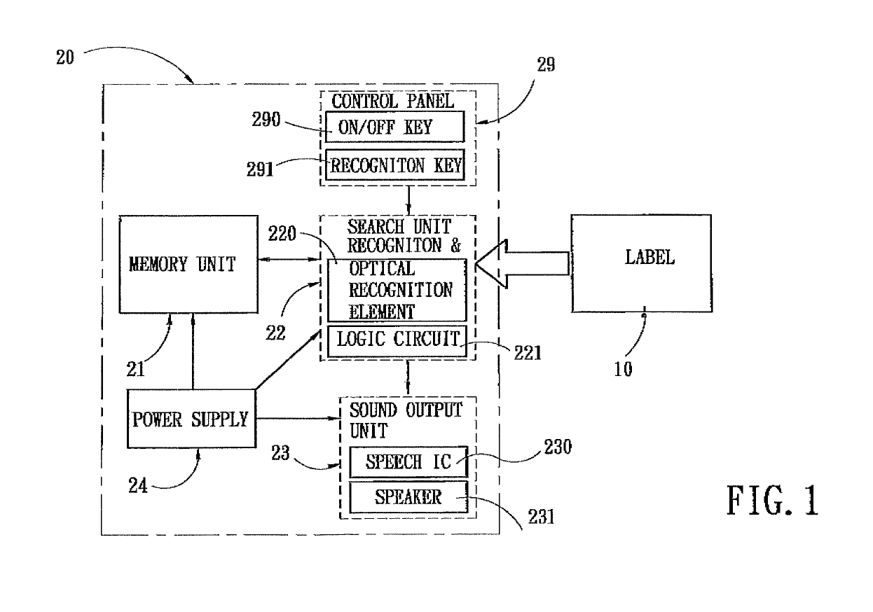

As shown in FIG. 1, an audio assisted instructional device includes a label 10 carrying index of sound information to be learned, and an audible instructional unit 20 for recognizing the label and generating correspondent sounds of instruction.

The label 10 is preferably made with barcodes. The barcodes are printed directly on the object to be learned, or on a sticker to be adhered to the object. Of course, laser-printed stickers can also be used.

The audible instructional unit 20 is mainly composed of a memory unit 21 a recognition mid search unit 22, and an audio output unit 23. The memory unit 21 is a module of memory chips for storing digitized sound information. The sound information is stored as a relative database correspondent to the barcode of label 10.

The recognition and search unit 22 is composed of an optical recognition element 220 and a logic circuit 221. After scanning a label 10, the recognition and search unit 22 recognizes the content of the label 10 through optical recognition process, then searches the correspondent sound information stored in the memory unit 21 to get the sound information relative to the label 10 from the database.

The audio output unit 23 includes a speech IC 230 and a speaker 231 for playing the sound information retrieved by the recognition and search unit 22.

The audible instructional unit 20 also includes a power supply 24, such as batteries or rechargeable batteries, for supplying the required electrical power; and a control panel 29 for operation. The control panel 29 at least includes an on/off key 290 for turning on and off the unit and a recognition key 291 for staining the label recognition and sound playing.

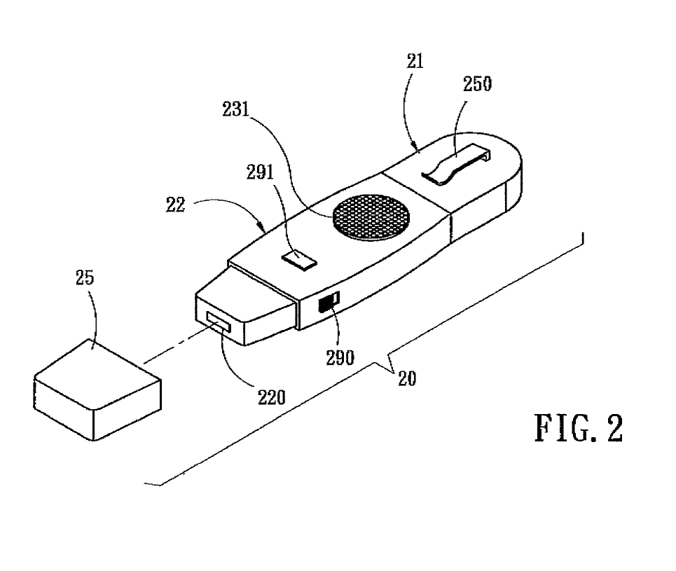

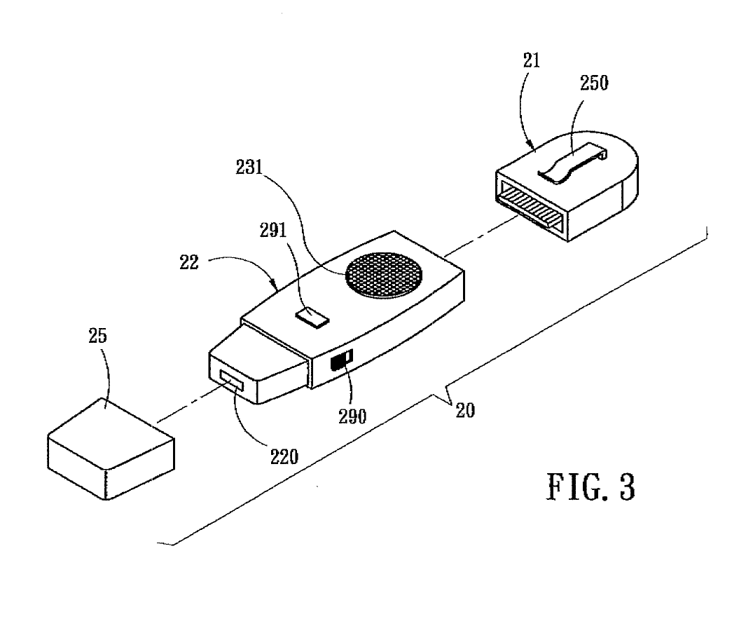

As shown in FIGS. 2 and 3, the audible instructional unit 20 is preferably shaped as a pen for better operation and carrying purposes. The “pen” includes a cap 25 at the front end for covering and protecting the optical recognition element 220 when being unused; and a clip 250 for easy carrying. The memory unit 21, recognition and search unit 22 and the audio output unit 23 can be incorporated into a unitary module as shown in FIG. 2. But, the memory unit 21 is preferably detachable from the unitary module of recognition and search unit 22 and audio output unit 23 as shown in FIG. 3. The detachable memory unit 21 makes the database of sound information changeable and expandable, so that a different memory unit 21 with different content can be attached to the module of recognition and search unit 22 and audio output unit 23 to expand the usage and save cost.

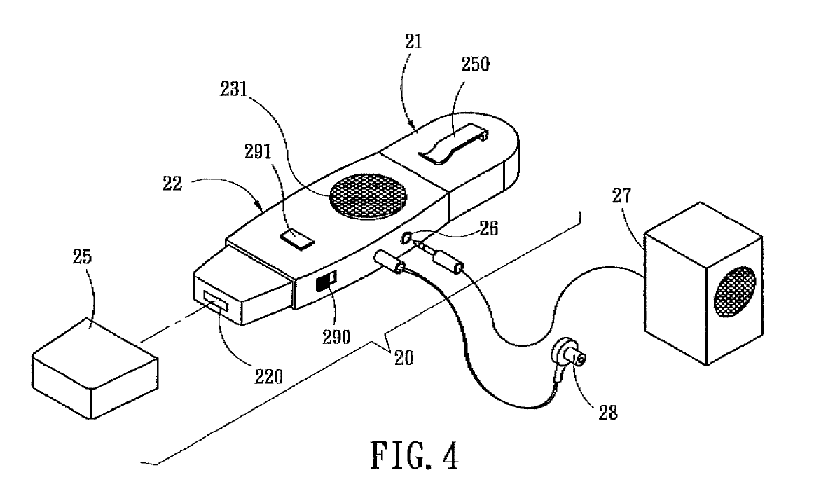

The label 10 can be attached to a book or other object that is to be learned. The audible instructional unit 20 can scan the label 10 with optical recognition element 220 and generate sound information for a real time instruction. The sound information can be name of an object, description of an object or music. The object can be a bock or any kind of things that a label can be printed or adhered to. Therefore, when the audible instructional unit 20 scanning the label 10, the recognition and search unit 22 will recognize the content of the label 10 through optical recognition process, then search the correspondent sound information stored in the memory unit 21 to get the sound information relative to the label 10, and play the sound, via the speech IC 230 to the speaker 231. The sound can also be played through an external speaker 27 or an earphone 28 via a connectors as shown in FIG. 4, Therefore, even children before school age can learn by themselves, without the help of parents, by using the audible instructional unit 20 and get audible instructions to learn names of objects or other knowledge.

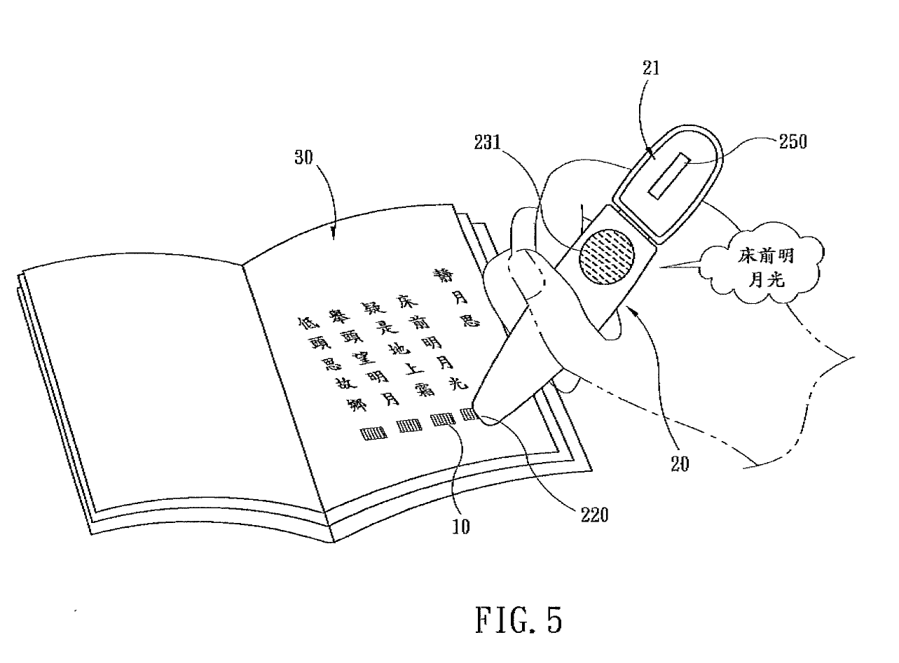

An example of application of the present invention is shown in FIG. 5. In a Chinese poetry collection 30, under each line of text, a label 10 containing index for relative reading or speech instruction is printed in the memory unit 21 of the audible instructional unit 20, sound information data correspondent to the label 10 is stored. Therefore, when the user uses the instructional unit 20 with a label 10, the correspondent speech or other audible instructions will be generated through the memory unit 21, the recognition and search unit 22 and the audio output unit 23. As for the location and number of the labels 10, they can be suitably designed to meet requirements of the instructional purpose.

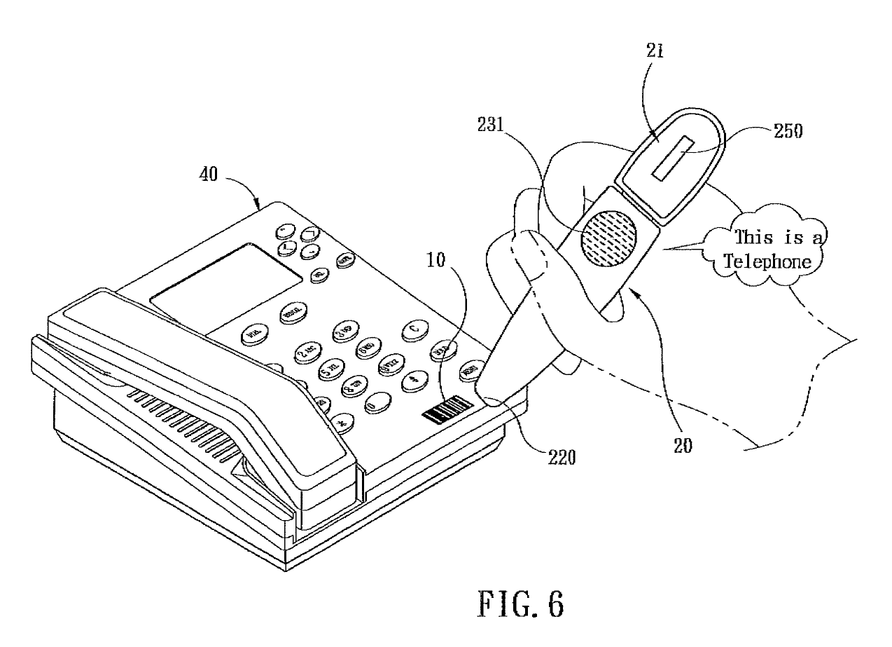

FIG. 6 shows a second example of application of the present invention. A label 10 is attached to an object, e.g., a telephone 40. The label 10 is a sticker adhered to the object. So, when a child using the instructional unit 20 to read the label 10, the instructional unit 20 will generate a sound, like “This is a telephone” or further information about the telephone, to instruct the child.

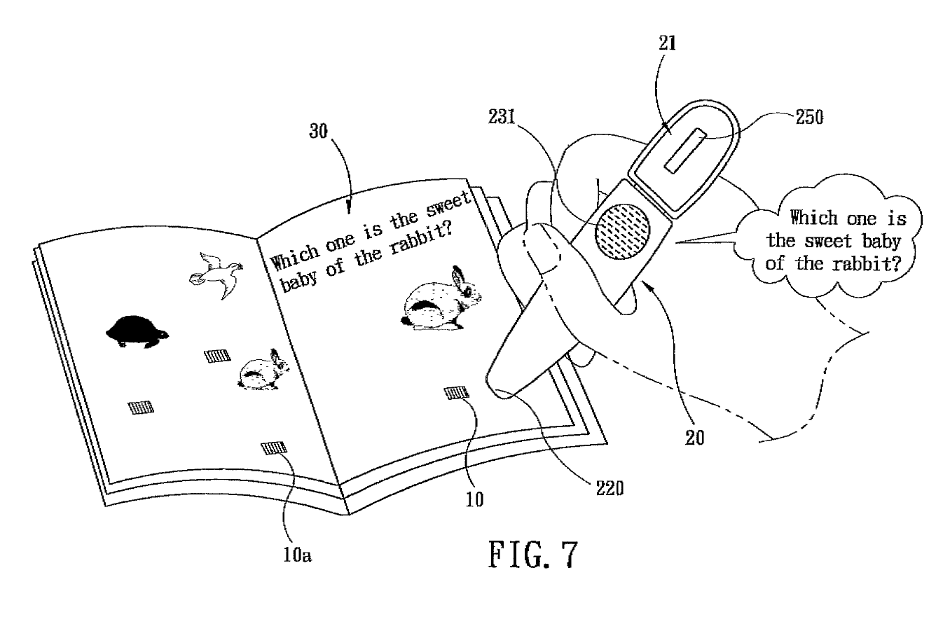

FIG. 7 shows a third example of application of the present invention. Several labels 10 are printed in a media (a textbook or the like) to compose an interactive learning. For example, the child first uses the instructional unit 20 on a label 10 to get a question “Which one is the sweet baby of the rabbit?”. Then he or she can further point out an answer with the instructional unit 20. When the correct label 10a is scanned, the instructional unit 20 will give an appreciation “Very good” to encourage further learning. As a result, the audible instructional unit 20 can provide audible instructions to the users through the labels 10 and a specific memory unit 21. The users can even be children who don't know any words but figures.

The sound information is not limited to speech. Since sounds can overlap, and music can also be he object of learning, an example of application is that the user can use the instructional unit 20 on a certain label 10 to start some background music before starting other learning from a medium.

In conclusion, the advantages of the present invention are as follows:

1) It provides a real-time audible instruction to the user freely and promptly from a designated position, without the limitation that a tape has;

2) Any object or printed material can be the medium or object for learning;

3) The memory unit is changeable or expandable that different sound information can be easily added and used;

4) A pen-shaped instructional unit is provided for easy carrying and operation;

5) Operation is simpler than that of a multimedia computer or a tape player, so that even small children can easily operate,

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. All audio assisted instructional device for being used with an object to be learned, comprising:
a label being marked on said object and carrying information relative to contents for learning; and
an audible instructional unit composed at least of:
a memory unit, for storing sound information correspondent to the information of said label;
a recognition and search unit, for recognizing said label and retrieving said sound information from said memory unit,
an audio output unit, for displaying said retrieved sound information;
a power supply, for supplying electrical power to the device; and
a control panel comprising at least an on/off key for turning on and off said device and a recognition key for starting said label recognition and sound playing.

2. An audio assisted instructional device according to claim 1 wherein said label contains a barcode.

3. An audio assisted instructional device according to claim 1 wherein said label is a laser-printed label.

4. An audio assisted instructional device according to claim 1 wherein said label is printed on said object to be learned.

5. An audio assisted instructional device according to claim 1 wherein said label is a sticker.

6. An audio assisted instructional device according to claim 1 wherein said sound information includes name of said object.

7. An audio assisted instructional device according to claim 1 wherein said sound information includes relative information of said object.

8. An audio assisted instructional device according to claim 1 wherein said sound information includes music.

9. An audio assisted instructional device according to claim 1 wherein said sound information includes questions and answers concerning to said object.

10. An audio assisted instructional device according to claim 1 wherein said audible instructional unit is of pen shape; said memory unit is detachable from said audible instructional unit for being replaceable with another memory unit containing different sound information.

11. An audio assisted instructional device according to claim 10 wherein said audible instructional unit includes a pen clip.

12. An audio assisted instructional device according to claim 1 wherein said memory unit includes memory chips for storing digitized sound information.

13. An audio assisted instructional device according to claim 1 wherein said recognition and search unit includes an optical recognition element and a logic circuit.

14. An audio assisted instructional device according to claim 1 wherein said audio output unit includes a speech IC and a speaker.

15. An audio assisted instructional device according to claim 14 wherein said audio output unit further includes an output connector for connecting an earphone.

16. An audio assisted instructional device according to claim 14 wherein said audio output unit further includes an output connector for connecting an external speaker.
